(19) United States
(12) Patent Application Publication
(10) Pub. No.: US 2016/0333747 A1
(43) Pub. Date: Nov. 17, 2016

(54) Prime Mover with Recovered Energy Induced Source and Sink Temperature

(71) Applicant: Jay Stephen KanFman, Kingston, NH (US)

(72) Inventor: Jay Stephen KanFman, Kingston, NH (US)

(21) Appl. No.: 14/711,859

(22) Filed: May 14, 2015

(51) Int. Cl. F01K 25/10; F17C 9/04

(52) U.S. Cl. CPC F01K 25/10; F17C 9/04

(57) ABSTRACT

A system for using recovered energy to increase the source to sink temperature differential for heating and cooling the working fluid of a prime mover, and in particular to a heat of compression braking source and liquefied or solidified air sink.

### FIELD OF THE INVENTION

The present invention relates to prime movers utilizing recovered energy to increase the source to sink temperature differential for heating and cooling the working fluid, and in particular to a heat of compression braking source and liquefied or solidified air sink.

### BACKGROUND OF THE INVENTION

Since the 1970's researchers have increased global efforts to find sustainable energy sources for use in electric power generation and transportation. Fossil fuels are increasingly consumed and an energy crisis has ensued. It is recognized that new energy technologies must be rapidly developed. Moreover, because products of combustion are unhealthy and dangerous for the environment, technologies that use “clean” energy sources are in demand. Finally, warnings of the steady increase in temperature of the earth's atmosphere, or “greenhouse effect” advise the development of energy technology that minimizes the release of greenhouse gases.

Replacement sources for fossil fuels, including wind, solar, and recovered energy are intermittently available, leading to the need for reliable energy storage devices. To date lithium-ion batteries are leading in development over other storage concepts including flywheel, compressed air, thermal and pumped hydro, however they are expensive, hazardous, heavy and resource and charge cycle limited. As an alternative, researchers have considered liquefied gases as a promising medium for clean energy storage. The dominant advantages of liquefied or solidified air storage are the global distribution of air and its established use as a prime mover working fluid. A “liquid nitrogen economy” was proposed in 1974, according to Kleppe, J. and Schneider, R., “A Nitrogen Economy”, ASEE. The proposed system would employ wind, solar, recovered energy and low cost off-peak electricity to power refrigerant phase change, while providing a very high level of energy sustainability and reversing man made climate change.

Efforts to establish a Liquid Nitrogen or Air Economy have been met with only a few objections These are the inefficiency of liquefaction and solidification, potential asphyxiation due to accidental release of nitrogen coolant versus fire hazard with oxygen enriched air, and vaporization of the refrigerant during standby. These objections must be considered in context of the reduced fuel consumption and the universal availability of renewable energy to drive air liquefiers and solidifiers. Economical refrigerant consumption in conjunction with reduced fuel consumption minimizes the need for efficient liquefaction and solidification, and the consequences of refrigerant leakage including vaporization during standby. Increased demand for liquefied natural gas in recent years has led to improved liquefaction technology, with figure of merit approaching 0.5. This technology is increasingly applied to liquefaction of air and nitrogen.

### PRIOR ART

Prior liquid air engines have been built and tested for both vehicle and stationary use. The vehicle applications, with reciprocating expanders, were all fuel-less for urban zero emission use, according to:

Knowlen, S., et al, “Ultra-Low Emission Liquid Nitrogen Automobile” SAE-1999-0102932, U. of Washington, 1999

Ordonez, C. et al, “Cryogenic Heat Engines for Powering Zero Emission Vehicles”, IMEECE2001/PID-25620, U. of N. Texas, 2001

Bondarenko, S. et al, “Development of Cryocar on Basis of Liquid Nitrogen”, Proceedings of the eighth “Cryogenics 2004” IIR International Conference, Ukraine, 2004

Dearman, P., “Liquid Air in the Energy and Transport Systems”, ISBN:978-0-9575872-2-9, Centre for Low Carbon Futures, UK, 2013.

The stationary applications were fired gas turbines using off-peak electric powered liquefiers including a 2000 kW plant in Japan and a 350 kW plant in the UK, according to:

Kishimoto, K. et-al, “Development of Generator of Liquid Air Storage Energy System”, Mitsubishi Heavy Industries Technical Review, Vol. 35 No. 3, 1998, Japan

Centre for Low Carbon Futures, “Liquid Air in the Energy and Transport Systems”, ISBN:978-0-9575872-2-9, UK, 2013.

Both the vehicle and stationary engines operated on a Rankine cycle with pressure ratio from about 5 to 20 MPa (50 to 200 atm). Liquefied air consumption in all of these applications is excessive and can be improved by increased energy recovery and optimum engine pressure ratio, as well as increased heat source temperature in vehicle application. Use of reciprocating expanders in vehicle application was intended as a first step in development of a liquid air economy. Liquefied air consumption of the U. of Washington Cryocar was approximately 2.6 kg/km (9.3 lb/mi) at 80 km/hr (50 mph) based on a curb weight of 950 kg (2100 lb), 7.5 kW (10.0 HP) and specific energy of 300 kJ/kg (130 Btu/lb) of liquid air. Performance is higher by approximately 50% than the other three vehicles due to a unique quasi-isothermal expander. Estimated driving range based on 180 kg (400 lb) of liquefied air capacity is 70 km (43 mi) with a drag coefficient of 0.29 and frontal area of 2.2 m² (24 ft²). Liquefied air consumption for the 2000 kW gas turbine is 0.4 kg/s (8.8 lb/s) with a specific energy of 500 kJ/kg (215 Btu/lb) of liquid air and fuel consumption of 240 kg/hr (530 lb/hr). Performance is considered typical for similar pressurized liquid air turbines.

According to; Ordonez, C., “Liquid nitrogen fueled, closed Brayton cycle cryogenic heat engine”, Energy Conversion & Management, Elsevier.com, U. of North Texas, 1999, it was shown that least pressure in a Brayton cycle delivers highest performance with a cryogenic heat sink. Subsequently, U.S. Pat. No. 7,854,278 B2 (2010) to Kaufman, J. S, the applicant of the present invention, showed that injection of cryogen into the compressor of a gas turbine results in quasi-isothermal compression with highest performance at an optimum pressure ratio. This patent describes a vehicle, comparable to the Cryocar, developing 7.5 kW (10.0 HP) with liquefied air consumption reduced to 0.2 kg/km (0.8 lb/mi) at a specific energy of 1150 kJ/kg (500 Btu/lblqa) and gasoline consumption of 43 km/l (100 mpg). The concept does recover all available vehicle energy.

### SUMMARY OF THE INVENTION

The present invention is a system to maximize the source to sink temperature differential in a prime mover for economizing consumption of liquefied air. In its most basic form, the system utilizes recovered energy for heating working fluid to a gas expander while rejecting heat to a refrigerant cooled sink, sufficient to continuously liquefy a portion of the fluid returning to a working fluid sink compressor.

In a first embodiment of the present invention, the heat source is braking heat of compression recovered during deceleration of a motor vehicle and the heat sink is liquefied air, which is imported to a storage system of the vehicle from an external supply. Combined metal mass of a brake compressor and a gas expansion engine temporarily stores the recovered heat, which vaporizes the liquefied air via compressed transfer air and a recovery heater in thermal contact with the engine. An engine generator and associated control system delivers electric power to motorized wheels for accelerating and maintaining vehicle speed.

In a second embodiment of the present invention, added heat source capacity is by wind driven heat of compression recovered during high-speed vehicle operation. Combined metal mass of a wind driven compressor and the engine temporarily stores the recovered heat, which vaporizes the liquefied air via compressed transfer air and the recovery heater.

In a third embodiment of the present invention, a jet compressor helps to lower temperature limitations of the brake compressor. It circulates and boosts temperature of the transfer air through the recovery heater, while driven by motive transfer air from the brake compressor.

In a fourth embodiment of the present invention, heat storage capacity of the recovery heater is increased by insertion of high specific heat material between heating and cooling sides of the heater.

In a fifth embodiment of the present invention, supplementary combustion heating of the working fluid provides energy for start-up of the engine in parallel working fluid flow relation, and for power boost in series working fluid flow relation with the compressed fluid heat source.

In a sixth embodiment of the present invention, consumption of liquefied air is further economized by re-liquefaction of the working fluid in the sink compressor. A portion of working fluid is cooled by contact with a cold head of a cryogenic vacuum chamber, which produces solidified air.

In a seventh embodiment of the present invention, direct contact cooling of working fluid with increased thermal conductivity is enabled by a porous media surface of the cold head containing solidified air within the pores of a matrix structure.

In an eighth embodiment of the present invention, a turbine expander provides prime mover power output.

Therefore, it is an aspect of the present invention to provide an improved prime mover for highest thermal efficiency, least liquefied air and fuel consumption, minimal emissions of greenhouse gases and minimal size and cost of components. These aspects are not meant to be exclusive and other features and advantages will be readily apparent to those of ordinary skill in the art when read in conjunction with the following description, appended claims and accompanying drawings.

### BRIEF DESCRIPTION OF THE DRAWINGS

In all figures, solid, non-emboldened lines represent a gas or liquid. Broken lines represent electricity. All systems or system components are labeled with three digit even numbers, the first digit being the figure number. Gases, liquids and solids are labeled with odd numbers.

FIG. 1 is a schematic diagram of a chassis of a motor vehicle of the present invention with a prime mover, drive train and brake driven heat of compression recovery system.

FIG. 2 is a schematic detail of a supplementary wind driven heat of compression recovery system of the present invention.

FIG. 3 is a schematic detail of an alternate heat of compression recovery system of the present invention with a jet driven boost compressor.

FIG. 4 is a schematic detail of a supplementary heat storage device of the heat of compression recovery system of the present invention.

FIG. 5 is a schematic diagram of a gas turbine prime mover of the vehicle chassis of the present invention.

FIG. 6 is a schematic diagram of an alternate heat sink of the prime mover of the present invention with cooling by a solidified refrigerant.

FIG. 6A is a schematic detail of an alternate heat transfer surface of the solidified refrigerant heat sink of the present invention.

### DETAILED DESCRIPTION OF THE INVENTION

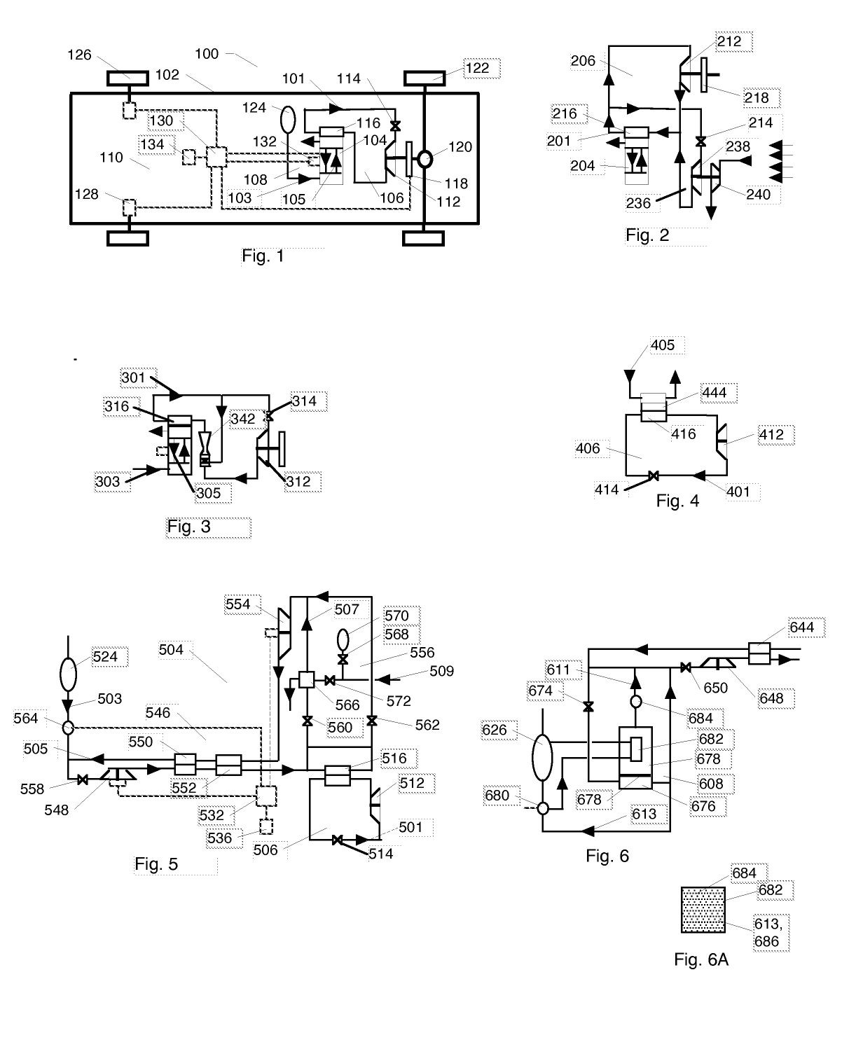

FIG. 1 is a schematic diagram of a typical embodiment of a motor vehicle chassis 100 of the present invention including a frame 102 and a gas turbine engine 104 with a brake compression heat source 106 and a refrigerant cooled heat sink 108. Engine 104 provides prime mover power to an electric wheel drive 110. A brake compressor 112 circulates transfer air 101 in heating source 106 under control of a recovery valve 114 while the heat of compression is stored in the metal mass of a recovery heater 116 and engine 104. Brake compressor 112 is activated by an electric clutch 118, a geared axle 120 and front wheels 122 (2 typ.). Sink 108 is cooled by liquid air 103 from a dewar 124 while chilled primary working fluid air 105 circulates between source and sink and an equivalent quantity of residual air is vented. Drive 110 includes rear wheels 126 (2 typ.), driven in turn by electric motors 128 (2 typ.), a controller 130, a generator 132 and engine 104. A battery 134, charged by generator 132 via controller 130, provides power for auxiliary use including actuation of valve 114 and clutch 118.

A gas turbine (micro-turbine) suitable for conversion to a heat of compression source and refrigerant cooled sink is available from Capstone Turbine Corp. of Chatsworth, Calif. An air-bearing compressor suitable for high temperature compression heating is available from R&D Dynamics Corp. of Bloomfield, Conn.

The engine heat source is provided by recovered vehicle energy up to an exemplary cruising speed of 80 km/hr (50 mph). The heat sink is provided by liquefied air imported to the dewar. Potential braking energy recovery is estimated at 80% of turbine-generator shaft power due to “free wheeling” of the gas turbine with working fluid compression inactive during vehicle deceleration. Air bearings in the brake compressor enable maximum source temperature of 840° C. (1540° F.), which is limited by disengagement of the clutch. A braking compression ratio of 4 boosts transfer air temperature from an estimated 20° C. (70° F.) to 840° C. (1540° F.) by compounding heat of compression in the closed loop. At cruising speed, estimated gasoline mileage is 170 km/l (400 mpg) and liquefied air consumption is 44 kg/hr (20 lb/hr) in a vehicle with a curb weight of 1600 kg (3500 lb) and drag coefficient times frontal area of 0.64 m² (7 ft²). Estimated driving range, based on 90 kg (200 lb) liquefied air capacity, is 800 km (500 mi). For comparison, a hybrid electric vehicle with energy recovery limited to 30% would require about (2000 lb) of lithium-ion batteries.

Additional embodiments of the present invention are shown in FIGS. 2, 3, 4, 5 and 6. FIG. 2 is a schematic detail of a wind driven compression heat source 236, connected in parallel flow relation with brake driven heat source 206. A wind recovery compressor 238 driven by a wind turbine 240 circulates transfer air 201 for heating source 236 under control of recovery valve 214. A wind turbine suitable for driving the brake compressor is available from R&D Dynamics Corp. of Bloomfield, Conn.

At an exemplary vehicle highway speed of 120 kph (75 mph), potential wind recovery is estimated at 25% of turbine-generator shaft power, operating on the differential head between vehicle impact flow and accelerated flow at the windshield periphery. With combined brake and wind recovery, estimated gasoline consumption is 54 km/l (125 mpg) with the engine developing 23 kW (31 HP) at 84,000 rpm and pressure ratio of 2.5. Liquefied air consumption is 14 kg/hr (25 lb/hr).

FIG. 3 is a schematic diagram of heat source 306 with a supplementary jet compressor 342 for boosting pressure of a brake compressor having limited temperature capability. The jet compressor is in a closed suction loop with motive air in series flow relation with brake compressor 312. A suitable jet-compressor for is available from Fox Venturi Products of Dover, N.J.

The engine operates on recovered vehicle energy up to a cruising speed of 80 km/hr (50 mph). Braking compression ratio of 5 is boosted to 10 by the jet compressor, raising transfer air temperature from atmospheric to 840° C. (1540° F.).

FIG. 4 is a schematic detail of recovery heat exchanger 416 with addition of heat storage media 444 for increasing heat storage capacity of heat exchanger 416. Sensible heat storage media, such as firebrick exchanges heat, as required, between heat input and output sides of heat exchanger 416 under control of recovery valve 414. A dense firebrick suitable for high temperature thermal storage in the recovery heat exchanger is available from Whitacre Greer Co. of Alliance, Ohio.

Estimated heat storage is based on acceleration of the vehicle to design point speed in 40 sec., per established highway driving cycle, requiring 14 kW (19 HP) and 1000 kJ (950 Btu) storage capacity. Assuming 136 kg (300 lb) of heat storage capacity, including 90 kg (200 lb) of engine and heat exchanger mass plus 45 kg (100 lb) fire brick, a turbine inlet gas temperature variation of +/−1% is maintained.

FIG. 5 is a schematic diagram of engine 504 with a working fluid supply system 546. Liquid air 503, drawn from dewar 524 under control of a liquid air pump 564, combines with recirculated primary working fluid air 505 via an electrically driven sink compressor 548 through a chiller 550, a recuperator 552 and recovery heater 516, to a turbine 554. A combustion heat source 556 provides supplementary heat for start-up and added power. Air 505 continues to turbine 554 in parallel flow relation with bypass air 507 under control of a chilled air valve 558 and a source bypass valve 560 or in series flow relation under control of a combustor bypass valve 562, respectively. As required, bypass air 507 is heated, in turn, by secondary air 509 and combustion of fuel in a combustor 566 under control of a fuel valve 568 of a tank 570 and a secondary air valve 572. A 65 kWe (87 HP) peak recuperated gas turbine, which can be modified to incorporate the independent sink compressor drive of the present invention, is available from the Capstone Corporation of Chatsworth, Calif. Special cryogenic components including the chiller and compressor are available from Chart Industries of Garfield Heights, Ohio and Barber-Nichols of Arvada, Col., respectively.

Engine performance is based on a recuperated two stage radial turbine with compressed primary air from the external supply, developing 8.2 kW (11 HP) at 56,000 rpm. A closed cycle with an externally fired combustor precludes products of combustion and atmospheric moisture in the working fluid to avoid potential freezing. With liquefied air entering the sink compressor at −190° C. (−315° F.), the engine is started by firing the combustor to a turbine inlet temperature of 840° C. (1540° F.), the combustor then being placed in standby mode. Recovered braking energy provides an estimated 85% of energy to drive the vehicle at the 80 km/hr (50 mph) design point while expanding liquefied air provides the remaining 15%. Engine efficiency is 75% at 56,000 rpm and compression ratio of 1.5. The combustor is fired to enable acceleration to 84,000 rpm at a compression ratio of 2.5. Results are based on a recuperator effectiveness of 95% and sink compressor work equal to 12% of turbine-generator shaft power. For comparison, a typical gasoline engine in the same application has a cycle efficiency of about 18%.

FIG. 6 is a schematic diagram of a solid refrigerant cooled heat sink 608. A portion of working fluid entering sink compressor 648 is diverted via a sink diverter valve 674, liquefied in a cold head 676 in contact via an interface 678 with a vacuum chamber 678, and returned to the intake of sink compressor 648. Cooling of cold head 676 is by solidified air formed during circulation of liquefied air by a liquefied air pump 680. The liquefied air circulates through a bucket 682 while sublimed air vapor 611 is drawn to the intake of sink compressor 648 by a vacuum pump 684 and melt 613, passed through interface 678, is drawn back to pump 680. The vacuum chamber and other cryogenic components are available from PHPK Technologies of Columbus Ohio.

While the source and sink would normally share recovered vehicle energy in an optimum combination, exemplary performance of the sink is illustrated herein with all recovered braking energy; the source being provided by combustion of fuel. A continuous supply of liquefied air is maintained as recovered braking energy equal to 80% of net engine power at the 80 km/hr (50 mph) design point charges the battery to drive the vacuum pump. Reduction of vapor pressure to 0.12 atmospheres provides circulation of alternately melting and solidifying liquid air through the sink. Liquefied air at 14 kg/hr (30 lb/hr), from the vacuum chamber to the sink compressor, maintains quasi-isothermal compression, while the sink absorbs 0.75 kW (2580 Btu/hr) to melt 109 kg/hr (240 lb/hr) of solidifying air. At highway speed of 129 km/hr (75 mph) liquefied air consumption increases to 17 kg/hr (38 lb/hr), requiring 0.9 kW (3220 Btu/hr) absorption by the sink.

FIG. 6A is a plan view detail of a porous interface 682 between the cold head and vacuum chamber for increasing thermal conductivity of the solidified air. A typical interface is constructed of a matrix of aluminum strips 684 retaining solidified air 613 between interstitial spaces 686. Thermal conductivity is increased by more than an order of magnitude, as compared to an all metal interface. The interface material is available from Porvair Fuel Cell Technology of Hendersonville, N.C.

Although the present invention has been described in considerable detail with reference to certain versions thereof, other versions would be readily apparent to those of ordinary skill in the art. For example, features may be added to reduce refrigerant consumption including alternate refrigerants, turbine exhaust gas recirculation using a liquid air driven jet compressor, latent heat storage with selected compounds, and alternate systems for injection and transfer of refrigerant from sink to working fluid. Therefore, the spirit and scope of the appended claims should not be limited to the description of preferred embodiments contained herein.

What is claimed is:

1. A prime mover comprising refrigerant cooled sink means and compressed fluid heat source means with wind or moving vehicle drive means, wherein differential temperature between said source means and sink means is the heat of compression temperature due to said source means minus the refrigerant temperature in said sink means.

2. The compressed fluid heat source means of claim 1 comprising transfer fluid flow control means, wherein a transfer fluid, compressed by said source means, heats the working fluid continuing from sink compression means of said prime mover to expansion means of said prime mover.

3. The compressed fluid heat source means of claim 2 comprising multiple stage compression means with at least one jet compression stage, wherein said jet compression stage increases pressure and temperature of the transfer fluid from a first stage of said heat source means.

4. The prime mover of claim 3 comprising supplementary heat source means, wherein a working fluid portion heated by said supplementary heat source means is in flow relation, selected from the group consisting of series and parallel flow, with the remaining working fluid heated by said compressed fluid heat source means.

5. The prime mover of claim 4 comprising supplementary heat exchange means and heat storage means, wherein heat due to said compressed fluid heat source means is stored for transfer to working fluid continuing from said sink compression means to said expansion means.

6. The sink means of claim 5 comprising refrigerant phase change means, wherein refrigerant is alternately liquefied during absorption of heat of compression of said sink compression means and then solidified by vacuum pressure in said sink means, while sublimed vapor of the refrigerant is discharged to said sink compression means.

7. The phase change means of claim 6 comprising direct contact heat transfer enhancing means selected from the group consisting of heat transfer surface treatment means and refrigerant transfer means, wherein heat is transferred from working fluid to solidified refrigerant in said phase change means.

8. A motor vehicle comprising an axle driven braking compressor and a solidified refrigerant cooled sink compressor of a gas turbine prime mover, wherein source to sink differential temperature of said prime mover equals heat of compression temperature in said braking compressor minus refrigerant temperature in said sink compressor.

9. The prime mover of claim 8 comprising a flow controller, a working fluid valve and a transfer fluid valve, wherein a transfer fluid discharged from said braking compressor during deceleration of said vehicle heats compressed working fluid from said sink compressor during acceleration and constant speed operation of said vehicle.

10. The prime mover of claim 9 comprising a supplementary fuel combustion heat source, wherein source to sink differential temperature of said prime mover is adjusted to control power output of said prime mover.

11. The prime mover of claim 10 comprising supplementary heat storage material and a storage heat exchanger, wherein heat from said braking compressor source is stored for transfer to working fluid entering an expansion turbine of said prime mover.

12. The sink compressor of claim 11 comprising a refrigerant phase change sink, wherein refrigerant imported to said vehicle is cyclically liquefied during absorption of heat of compression of said sink compressor and suctioned to a solid in a vacuum chamber of said sink.

13. The phase change sink of claim 12 comprising a sorbent heat transfer surface, whereby solidified air, formed in a porous matrix of said surface, absorbs heat from working fluid entering said sink compressor.

14. The phase change sink of claim 13 comprising a refrigerant flow path, wherein solidified air is transferred into working fluid entering said sink compressor.

15. The phase change sink of claim 14 comprising a vacuum pump, wherein refrigerant vapor, sublimed during suction and solidification of refrigerant in said chamber, is discharged to the intake of said sink compressor.

16. The source and sink of a prime mover of a motor vehicle comprising compression heating means of prime mover working fluid in said source and refrigerant cooling means of prime mover working fluid in said sink, wherein said heating means is driven by recovered energy of said vehicle.

17. The heat source means of claim 16 comprising transfer fluid flow control means, wherein wind or motor vehicle driven heat of compression of a transfer fluid, compressed by said source means, heats the working fluid entering expansion means of said prime mover.

18. The prime mover of claim 17 comprising supplementary working fluid heat source means with fuel combustion means, wherein source to sink differential temperature of said prime mover is adjusted to control power output of said prime mover.

19. The prime mover of claim 18 comprising supplementary latent heat storage means, wherein heat due to said source means is stored for transfer to working fluid continuing from said sink compression means to said expansion means.

20. The sink means of claim 19 comprising refrigerant phase change means, wherein a portion of stored refrigerant is cyclically liquefied during absorption of heat of compression of said sink compression means, suctioned to a solid, and reliquefied for continued absorption of heat of compression of said sink compression means.
